(19) United States
(12) Patent Application Publication
(10) Pub. No.: US 2026/0242689 A1
(43) Pub. Date: Aug. 20, 2026

(54) SHOCK ABSORBER AND HYDRAULIC OIL FOR SHOCK ABSORBER

(71) Applicant: Astemo, Ltd., Tokyo (JP)

(72) Inventors: Shingo MIYAKE, Hitachinaka-shi (JP); ThienNgan DAM, Hitachinaka-shi (JP)

(21) Appl. No.: 19/161,786

(22) PCT Filed: Feb. 14, 2024
(86) PCT No.: PCT/JP2024/005031

§ 371 Date: Sep. 3, 2025

(30) Foreign Application Priority Data
May 29, 2023 (JP) 2023-087631

(51) Int. Cl. C10M 169/04; B60G 13/08; B60G 17/08; C10M 105/38; C10M 129/68; C10N 40/08; F16F 9/06; F16F 9/36; F16F 9/50

(52) U.S. Cl. CPC C10M 169/04; C10M 105/38; C10M 129/68; F16F 9/062; F16F 9/36; F16F 9/50; B60G 13/08; B60G 17/08; B60G 2202/24; B60G 2204/62; B60G 2206/41; B60G 2500/104; B60G 2600/21; B60G 2800/162; B60G 2800/916; C10M 2207/281; C10M 2207/401; C10N 2040/08; F16F 2222/126; F16F 2224/025; F16F 2228/066; F16F 2230/30; F16F 2232/08; F16F 2234/02

(57) ABSTRACT

This shock absorber includes: a bottomed cylindrical cylinder; an oil seal member containing acrylonitrile-butadiene rubber at an opening of the cylinder; and a hydraulic oil sealed within the cylinder, in which the hydraulic oil contains a base oil and an additive added to the base oil, and the base oil contains a first fluid having a first viscosity and being a plant-derived fat and oil in which the number of molecules of polyunsaturated fatty acid groups contained in the total triglyceride content is greater than the number of molecules of monounsaturated fatty acid groups, and a second fluid having a second viscosity lower than the first viscosity and containing a fatty acid ester.

### TECHNICAL FIELD

The present invention relates to a shock absorber and a hydraulic oil for a shock absorber.

Priority is claimed on Japanese Patent Application No. 2023-087631, filed May 29, 2023, the content of which is incorporated herein by reference.

### BACKGROUND ART

Patent Document 1 discloses a liquid composition useful as an insulating fluid, including: a mixture of a natural glyceride and at least one fatty acid ester different from triglycerides, in which the fatty acids of the fatty acid ester include fatty acids derived from at least one vegetable oil or an equivalent natural resource. Patent Document 1 describes that 70% to 85% of the fatty acids constituting the mixture of the natural glyceride and the fatty acid ester is oleic acid, and that genetically modified high oleic acid, canola oil, soybean oil, sunflower oil, and the like can be used.

### CITATION LIST

### Patent Document

Patent Document 1: Published Japanese Translation No. 2014-534567 of the PCT International Publication

### SUMMARY OF INVENTION

### Technical Problem

In the related art, there has been a demand for a hydraulic oil for a shock absorber that imposes a low environmental burden, has excellent lubricity and wear resistance, and does not cause problems such as oil leakage.

In the related art, hydraulic oil based on mineral oil has been used in shock absorbers. However, considering the environmental burden, vegetable-based hydraulic oil can be considered as an alternative oil. However, when acrylonitrile-butadiene rubber is used as a sealing material for a shock absorber, the sealing material may swell because the polarity of a vegetable oil is closer to that of butadiene rubber than that of mineral oil. In addition, because a vegetable oil has a high viscosity, it may not be applicable as a hydraulic oil as it is.

The present invention provides: a shock absorber containing a hydraulic oil that imposes a low environmental burden, is capable of suppressing swelling of oil seal members, and has improved lubricity by reducing viscosity; and a hydraulic oil for a shock absorber.

### Solution to Problem

According to one aspect of the present invention, a shock absorber includes: a bottomed cylindrical cylinder; an oil seal member containing acrylonitrile-butadiene rubber at an opening portion of the cylinder; and a hydraulic oil sealed within the cylinder. The hydraulic oil contains a base oil and an additive added to the base oil, and the base oil is a fat and oil derived from plants, in which the number of molecules of polyunsaturated fatty acid groups contained in the total triglyceride content is greater than the number of molecules of monounsaturated fatty acid groups. This base oil contains a first fluid having a first viscosity and a second fluid having a second viscosity lower than the first viscosity and containing a fatty acid ester.

### Advantageous Effects of Invention

According to the present disclosure, it is possible to provide a shock absorber which includes an oil seal material of acrylonitrile-butadiene rubber, can suppress swelling of the oil seal material, and exhibits excellent sealing performance for a hydraulic oil. In addition, by employing a base oil containing a first fluid that is a plant-derived fat and oil in which the number of molecules of polyunsaturated fatty acid groups contained in the total triglyceride content is greater than the number of molecules of monounsaturated fatty acid groups, and a second fluid having a lower viscosity and containing a fatty acid ester, it is possible to provide a shock absorber equipped with a hydraulic oil that exhibits excellent lubricity and a low environmental burden.

### BRIEF DESCRIPTION OF DRAWINGS

FIG. 1 A cross-sectional view showing an overall configuration of a hydraulic shock absorber according to a first embodiment of the present invention.

### DESCRIPTION OF EMBODIMENT

Hereinafter, a shock absorber as a hydraulic shock absorber according to a first embodiment of the present invention will be described.

The present embodiment described below is specifically described to facilitate better understanding of the gist of the invention, and does not limit the present invention unless otherwise specified. In addition, the scale of the drawing used in the description of the embodiment shown below has been appropriately changed to enhance visibility of each part.

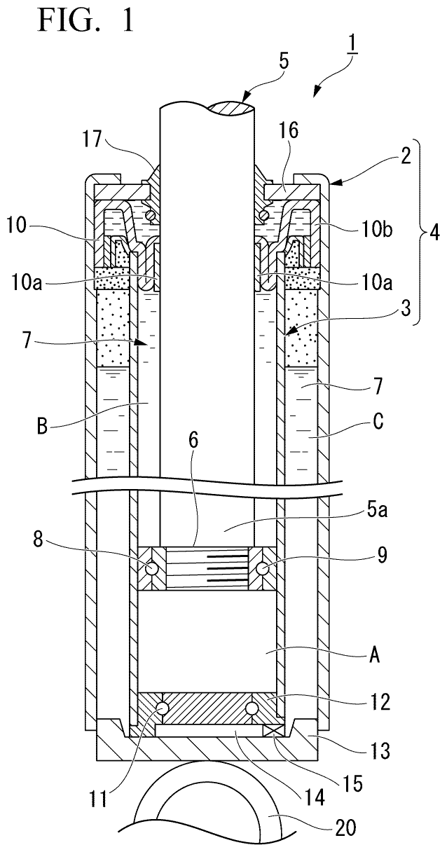

FIG. 1 is a vertical cross-sectional view showing a twin-tube type hydraulic shock absorber according to a first embodiment of the present invention. A hydraulic shock absorber 1 has a twin-tube type cylinder 4 consisting of a bottomed cylindrical outer tube 2 and a bottomed cylindrical inner tube 3 coaxially provided within the outer tube 2. A piston rod 5 having one end 5a inserted into the inner tube 3 and the other end protruding a predetermined length outward from the cylinder 4 is inserted into the cylinder 4 so as to freely reciprocate along the axial direction of the cylinder 4. A piston 6 is fixed to one end 5a of the piston rod 5, the piston 6 being slidable along the inner surface of the inner tube 3 and movable within the inner tube 3 along the axial direction of the inner tube 3. FIG. 1 shows the hydraulic shock absorber 1 in a state in which the axis of the outer tube 2, the inner tube 3, and the piston rod 5 is oriented in the vertical direction, with the bottom sides of the outer tube 2 and the inner tube 3 depicted downward and the other end of the piston rod 5 protruding outward from the inner tube 3 depicted upward.

The piston 6 has a function of partitioning the interior of the inner tube 3 into an oil chamber A and an oil chamber B, and is configured such that the volumes of the oil chambers A and B vary in accordance with the movement of the piston 6 within the inner tube 3. A reservoir chamber C partitioned by the outer tube 2 and the inner tube 3 is provided between the inner circumferential side of the outer tube 2 and the outer circumferential side of the inner tube 3. The oil chamber A, the oil chamber B and the reservoir chamber C are filled with a hydraulic oil 7 for a shock absorber, which will be described in detail below.

The piston 6 incorporates a plurality of flow paths communicating with the oil chambers A and B, and is provided with damping force generating devices 8 and 9, each incorporating a valve mechanism in these flow paths. When the piston 6 moves within the inner tube 3 and the volumes of the oil chambers A and B change, the hydraulic oil 7 for a shock absorber moves between the oil chambers A and B through the flow paths inside the piston. As a result, the piston 6 generates a damping force in response to the movement of the piston rod 5.

The bottom side of the inner tube 3 shown in FIG. 1 is closed by a bottom wall member 12 incorporating a bottom valve 11, and the bottom side of the outer tube 2 is closed by a bottom wall 13. The bottom portion of the inner tube 3 and the bottom portion of the outer tube 2 are disposed close to each other, with the bottom wall member 12 installed so as to overlap the bottom wall 13. A communication chamber 14 is formed between the bottom wall member 12 and the bottom wall 13. This communication chamber 14 communicates with the reservoir chamber C via a flow path member 15. The communication chamber 14 also communicates with the oil chamber A via the bottom valve 11. The piston 6 is configured such that, when it moves closer to the bottom wall member 12, the hydraulic oil 7 for a shock absorber can move from the oil chamber A to the reservoir chamber C via the bottom valve 11, the communication chamber 14, and the flow path member 15. In addition, the piston 6 is configured such that, when it moves in a direction away from the bottom wall member 12, the hydraulic oil 7 for a shock absorber can move from the reservoir chamber C to the oil chamber A via the flow path member 15, the communication chamber 14, and the bottom valve 11.

An oil seal member 17 containing acrylonitrile-butadiene rubber (NBR) is integrally provided with a cap 16 to liquid-tightly close an upper end portion of the inner tube 3. A through-hole is formed at a central portion of the cap 16, and the piston rod 5 is provided so as to extend through the through-hole. The annular oil seal member 17 is provided on the inner circumferential side of the through-hole and at a position in contact with the outer circumferential surface of the piston rod 5. In the present specification, acrylonitrile-butadiene rubber may sometimes be referred to as nitrile rubber, and unless otherwise specified, the term “nitrile rubber” used in the present specification refers to acrylonitrile-butadiene rubber.

In the configuration shown in FIG. 1, a rod guide 10 is provided inside the oil seal member 17 and within the upper end portion of the inner tube 3. This rod guide 10 has a tubular inner circumferential portion 10a and a tubular outer circumferential portion 10b, and is disposed such that the inner peripheral portion 10a is in contact with the outer circumferential surface of the piston rod 5, and the outer circumferential portion 10b is in contact with the inner circumferential surface of the upper end portion of the outer tube 2. The rod guide 10 is in liquid-tight contact with the piston rod 5 via the inner circumferential portion 10a, while allowing reciprocating movement of the piston rod 5.

The ring-plate-shaped cap 16 and the oil seal member 17 are integrally attached to the upper end portion of the outer tube 2 shown in FIG. 1. The rod guide 10 is held down by the cap 16. The piston rod 5 passes through the cover 16 and protrudes to the outside of the inner cylinder 3. The oil seal member 17 that closes a gap between the inner circumferential portion of the cap 16 and the outer circumferential portion of the piston rod 5 is provided therebetween integrally with the cap 16.

The hydraulic oil 7 for a shock absorber of the first embodiment is a fat and oil derived from plants, in which the number of molecules of polyunsaturated fatty acid groups contained in the total triglyceride content is 30% or more. The hydraulic oil 7 for a shock absorber mainly contains a base oil consisting of a first fluid having a first viscosity and a second fluid having a second viscosity lower than the first viscosity and containing a fatty acid ester.

The fatty acid ester contained in the second fluid is a fatty acid ester derived from a fatty acid that constitutes a triglyceride contained in a fat and oil derived from plants. The plant-derived fat and oil constituting the first fluid and the second fluid are preferably the same fat and oil.

The ratio of the first fluid to the second fluid is a ratio at which the kinematic viscosity (at 40° C.) of the base oil becomes 8 mPa·s to 15 mPa·s.

The ratio of the first fluid to the second fluid is, for example, in the range of 70:30 to 50:50.

The first fluid is a vegetable oil in which the content of polyunsaturated fatty acids (such as linoleic acid and linolenic acid) containing two or more double bonds is 50% or more, that is, the content of the polyunsaturated fatty acids is greater than the total content of other fatty acids. For example, soybean oil or sunflower oil is more preferable.

Soybean oil and sunflower oil have a lower viscosity than other vegetable oils, making it possible to reduce the content of the fatty acid ester for viscosity adjustment, which will be described below. Therefore, it is possible to suppress swelling of the oil seal material 17 and to provide the shock absorber 1 that is less likely to cause oil leakage.

For example, soybean oil contains about 51 mass % of linoleic acid and about 8.5 mass % of linolenic acid, and additionally contains about 24 mass % of oleic acid, about 11 mass % of palmitic acid, and about 2 to 3 mass % of myristic acid and stearic acid.

For example, sunflower oil contains about 70 mass % of linoleic acid and about 1 mass % of linolenic acid, and additionally contains about 18 mass % of oleic acid, about 7 mass % of palmitic acid, and about 4 mass % of stearic acid.

As described above, soybean oil and sunflower oil contain a large amount of polyunsaturated fatty acids. In other words, the content of other fatty acids such as oleic acid, which is a monounsaturated fatty acid, and saturated fatty acids is low. Thus, the first fluid is a fluid that contains a larger amount of polyunsaturated fatty acids than other fatty acids.

The first fluid is not limited to soybean oil or sunflower oil as long as the content of polyunsaturated fatty acids is greater than the other content, and may contain other oils such as waste oil in part or in whole. In other words, it is also possible to blend a fat and oil, that is, waste oil, in which the content of polyunsaturated fatty acids is less than the total content of other fatty acids into a fat and oil in which the content of polyunsaturated fatty acids is greater than the total content of other fatty acids. The blending ratio can be determined arbitrarily. Generally, as the nitrile content of nitrile rubber increases, resistance to swelling improves; therefore, by increasing the amount of ester in the second fluid, it is possible to use a larger amount of waste oil or the like (that is, maintain the viscosity). However, since cold resistance decreases, the ratio can be arbitrarily determined in consideration of the expected usage conditions.

The fatty acid ester contained in the second fluid is also derived from plants, like vegetable oils such as soybean oil and sunflower oil, which have low viscosities, and a fatty acid ester having a carbon number of about 10 to 20 can be used. The second fluid has a lower viscosity than the first fluid having a first viscosity. Therefore, by adding the second fluid to the first fluid, the viscosity of the hydraulic oil 7 for a shock absorber can be further reduced.

Here, the reason for limiting the kinematic viscosity at 40° C. as described above is that if the kinematic viscosity is less than 8 mPa·s, the viscosity decreases at high temperatures, and the desired damping force characteristics cannot be obtained. In addition, if the kinematic viscosity exceeds 15 mPa·s, the damping force characteristics during operation deteriorate, which particularly affects the ride comfort of an automobile equipped with the shock absorber 1 at low temperatures.

The hydraulic oil 7 for a shock absorber of the present embodiment may further contain any of a metal detergent, a dispersant, an anti-wear agent, an antioxidant, a corrosion inhibitor, a friction modifier, a pour point depressant, a defoaming agent, an oiliness improver, a viscosity index improver, and a rust inhibitor, which are generally added to hydraulic oils for shock absorbers.

As shown in FIG. 1, a mounting eye 20 is attached to an outer side of bottom wall 13. The hydraulic shock absorber 1 is used by mounting the distal portion on the outer side of the piston rod 5 and the mounting eye 20 between relatively movable members to be mounted.

In an automobile application, the hydraulic shock absorber 1 is used, for example, by connecting the outer end of the piston rod 5 to the vehicle body side of a vehicle and connecting the mounting eye 20 to the vehicle wheel side of the vehicle.

In the hydraulic shock absorber 1, the piston rod 5 and the piston 6 slide integrally within the cylinder 4, thereby changing the volumes of the oil chambers A and B. At that time, it is possible to generate a damping force by the flow resistance of the liquid acting on the damping force generating mechanisms 8 and 9 of the piston 6 and the bottom valve 11.

The hydraulic shock absorber 1 during vehicle travel is configured such that the piston rod 5 or the outer tube 2 repeatedly receives impact forces from outside in the axial direction thereof. Each time an impact force is received, the piston rod 5 moves in a compression direction or an extension direction, and a damping force acts at that time. In this manner, the hydraulic shock absorber 1 exhibits its function as a shock absorber used in a strut-type suspension of an automobile.

According to the hydraulic oil 7 for a shock absorber of the present embodiment, it is possible to contribute to carbon neutrality because a vegetable oil is used without using mineral oil.

In addition, since the hydraulic oil 7 for a shock absorber is derived from plants and is biodegradable, even if it is scattered or leaks into the surroundings, contamination treatment of soil or the like is easy, and the environmental burden becomes significantly small. In addition, since the hydraulic oil 7 for a shock absorber of the present embodiment can lower the proportion of the fatty acid ester for viscosity adjustment, it is less likely to cause swelling of the NBR constituting the oil seal member 17, and does not lower the sealing force, thereby making it possible to prevent problems such as oil leakage.

### Examples

As examples, soybean oil composed of polyunsaturated fatty acids at a percentage of 59.7 mass %, sunflower oil composed of polyunsaturated fatty acids at a percentage of 70.7 mass %, and esterified soybean oil were prepared, and base oils were prepared at the percentages described in Examples 1 to 5 below.

Next, additives such as a dispersant, an anti-wear agent, an antioxidant, a friction modifier, a pour point depressant, a defoaming agent, an oiliness improver, and a rust inhibitor were added to the base oils described in Examples 1 to 5 to prepare hydraulic oils for shock absorbers. Similarly, the following Comparative Examples 1 to 5 were prepared.

In Example 1, soybean oil composed of polyunsaturated fatty acids at a percentage of 59.7 mass % and an ester were blended at a ratio of 70:30, and the kinematic viscosity at 40° C. was adjusted to 14.8 mPa·s.

In Example 2, soybean oil and an ester were blended at a ratio of 60:40, and the kinematic viscosity at 40° C. was adjusted to 12.1 mPa·s.

In Example 3, soybean oil and an ester were blended at a ratio of 50:50, and the kinematic viscosity at 40° C. was adjusted to 9.4 mPa·s.

In Example 4, sunflower oil composed of polyunsaturated fatty acids at a percentage of 70.7 mass % and an ester were blended at a ratio of 60:40, and the kinematic viscosity at 40° C. was adjusted to 14.3 mPa·s.

In Example 5, sunflower oil and an ester were blended at a ratio of 50:50, and the kinematic viscosity at 40° C. was adjusted to 11.9 mPa·s.

Nitrile rubber having a nitrile content of 27%, which is usable at minus 30° C. as generally required for automobiles, was immersed in the oils of Examples 1 to 5, and the volume change after leaving them at 100° C. for 70 hours was measured. In addition, the pour point was measured. Minus 30° C. is a temperature lower than the average minimum temperature in Winnipeg in Canada and Moscow in Russia, which belong to the subarctic zone, and was set as a temperature at which common automobiles can sufficiently function in typical usage environments.

As comparative examples, rapeseed oil composed of polyunsaturated fatty acids at a percentage of 33.0% was newly prepared, and oils were prepared as shown in Comparative Examples 1 to 5.

In Comparative Example 1, soybean oil and an ester were blended at a ratio of 80:20, and the kinematic viscosity at 40° C. was adjusted to 18.1 mPa·s.

In Comparative Example 2, soybean oil and an ester were blended at a ratio of 40:60, and the kinematic viscosity at 40° C. was adjusted to 7.5 mPa·s.

In Comparative Example 3, sunflower oil and an ester were blended at a ratio of 70:30, and the kinematic viscosity at 40° C. was adjusted to 17.8 mPa·s.

In Comparative Example 4, rapeseed oil and an ester were blended at a ratio of 50:50, and the kinematic viscosity at 40° C. was adjusted to 18.7 mPa·s.

In Comparative Example 5, rapeseed oil and an ester were blended at a ratio of 40:60, and the kinematic viscosity at 40° C. was adjusted to 9.5 mPa·s.

TABLE 1

| | | Example | Example | Example | Example | Example |
|---|---|---|---|---|---|---|
| | | 1 | 2 | 3 | 5 | 6 |
| Soybean oil | | 70 | 60 | 50 | | |
| Sunflower oil | | | | | 60 | 50 |
| Ester | | 30 | 40 | 50 | 40 | 50 |
| Viscosity (mPa · s: 40° C.) | 8 to 15 | 14.8 | 12.1 | 9.4 | 14.3 | 11.9 |
| Pour point (° C.) | −30 or | −33 | −36 | −40 | −44 | −46 |
| | lower | | | | | |
| Volume change of medium | 10 or less | 6.8 | 8 | 9.8 | 7.8 | 9.4 |
| nitrile rubber (%) | | | | | | |

TABLE 2

| | | Comparative | Comparative | Comparative | Comparative | Comparative |
|---|---|---|---|---|---|---|
| | | Example 1 | Example 2 | Example 3 | Example 4 | Example 5 |
| Soybean oil | | 80 | 40 | | | |
| Sunflower oil | | | | 70 | | |
| Rapeseed oil | | | | | 50 | 40 |
| Ester | | 20 | 60 | 30 | 50 | 60 |
| Viscosity | 8 to | 18.1 | 7.5 | 17.8 | 18.7 | 9.5 |
| (mPa · s: 40° C.) | 15 | | | | | |
| Pour point | −30 or | −30 | −43 | −41 | −20 | −23 |
| (° C.) | lower | | | | | |
| Volume | 10 or | 4.9 | 12.1 | 6.5 | 10.2 | 13.5 |
| change of | less | | | | | |
| medium | | | | | | |
| nitrile rubber | | | | | | |
| (%) | | | | | | |

As is clear from the comparison between Table 1 and Table 2, it was found that Comparative Examples 1 to 5 did not satisfy some of the properties in terms of viscosity, pour point, and volume change.

In contrast, the viscosities of Examples 1 to 5 were within the desirable range of 8 to 15, the pour points were within the desirable range of −30° C. or lower, and the volume changes of the nitrile rubber were also small.

As described above, the tables are based on the premise of using nitrile rubber having a nitrile content of 27%, which is usable at minus 30° C. as generally required for automobiles. In cases where it is not necessary to satisfy this requirement, the nitrile content can be increased, and the proportion of the second fluid can be increased. For example, when the nitrile content is set to 50%, if the polyunsaturated fatty acid content in the first fluid is 30% or more, the viscosity, pour point, and volume change can be satisfied.

### INDUSTRIAL APPLICABILITY

According to the present disclosure, it is possible to provide a shock absorber which includes an oil seal material of acrylonitrile-butadiene rubber, can suppress swelling of the oil seal material, and exhibits excellent sealing performance for a hydraulic oil. In addition, by employing a base oil containing a first fluid that is a plant-derived fat and oil in which the number of molecules of polyunsaturated fatty acid groups contained in the total triglyceride content is greater than the number of molecules of monounsaturated fatty acid groups, and a second fluid having a lower viscosity and containing a fatty acid ester, it is possible to provide a shock absorber equipped with a hydraulic oil that exhibits excellent lubricity and a low environmental burden.

### REFERENCE SIGNS LIST

1 Hydraulic shock absorber (shock absorber)
2 Outer tube
3 Inner tube
4 Cylinder
5 Piston rod
6 Piston
7 Hydraulic oil for shock absorber
8, 9 Damping force generating mechanism
10 Rod guide
11 Bottom valve
17 Oil seal member
5 A, B Oil chamber
C Reservoir chamber

1. A shock absorber comprising:
a bottomed cylindrical cylinder;
an oil seal member containing acrylonitrile-butadiene rubber at an opening portion of the cylinder; and
a hydraulic oil sealed within the cylinder,
wherein the hydraulic oil contains
a base oil and an additive added to the base oil, and
wherein the base oil contains
a first fluid having a first viscosity and being at least partially formulated with a plant-derived fat and oil in which the number of molecules of polyunsaturated fatty acid groups contained in the total triglyceride content is greater than the number of molecules of other fatty acid groups, and
a second fluid having a second viscosity lower than the first viscosity and containing a fatty acid ester.

2. The shock absorber according to claim 1,
wherein a gas substantially free of oxygen is further sealed in the shock absorber.

3. The shock absorber according to claim 1, further comprising:
a piston provided inside the cylinder and which slides relative to the cylinder; and
a piston rod connected to the piston and configured to reciprocate in an axial direction of the cylinder relative to the cylinder while being in contact with the oil seal member.

4. A hydraulic oil for a shock absorber comprising:
a base oil; and
an additive added to the base oil,
wherein the hydraulic oil for a shock absorber is used in an environment exposed to acrylonitrile-butadiene rubber, and
wherein the base oil contains
a first fluid having a first viscosity and being a plant-derived fat and oil in which the number of molecules of polyunsaturated fatty acid groups contained in the total triglyceride content is 30% or more, and
a second fluid having a second viscosity lower than the first viscosity and containing a fatty acid ester.

5. The hydraulic oil for a shock absorber according to claim 4,
wherein the fatty acid ester contained in the second fluid is derived from a fatty acid that constitutes a triglyceride contained in a fat and oil derived from plants.

6. The hydraulic oil for a shock absorber according to claim 4,
wherein the plant-derived fat and oil constituting the first fluid and the second fluid are the same fat and oil.

7. The hydraulic oil for a shock absorber according to claim 4,
wherein the base oil is obtained by mixing the first fluid with the second fluid.

8. The hydraulic oil for a shock absorber according to claim 4,
wherein the base oil is obtained by modifying a part of the first fluid into the second fluid.

9. The hydraulic oil for a shock absorber according to claim 4,
wherein the proportion of the first fluid is greater than the proportion of the second fluid.

10. The hydraulic oil for a shock absorber according to claim 4,
wherein a ratio of the first fluid to the second fluid is a ratio at which the viscosity of the base oil becomes 8 mPa·s to 14 mPa·s.
